(19) United States
(12) Patent Application Publication
(10) Pub. No.: US 2006/0061486 A1
(43) Pub. Date: Mar. 23, 2006

(54) Method and apparatus for customizing traffic alerts

(75) Inventor: Eugene Luskin, Issaquah, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/946,844

(22) Filed: Sep. 22, 2004

(51) Int. Cl. G08G 1/095

(52) U.S. Cl. 340/907

(57) ABSTRACT

A traffic alert system in which a user may specify an alert profile that includes one or more routes of interest. The system monitors traffic problems for problems that might impact roads along the specified routes of interest. Alerts reporting such problems are sent to the user. Additional filter characteristics might be specified by the user as part of the alert profile to further restrict the number of alerts sent to each user. As a result, each user receives a relatively small number of alerts which are of high value to the user.

### BACKGROUND OF INVENTION

1. Field of Invention

This invention relates generally to traffic alert systems and more specifically to improved usability of such systems.

2. Discussion of Related Art

Information is available in many forms to aid motorists planning trips. MICROSOFT® Streets & Trips™ is an example of a mapping program that provides driving directions as well as estimated driving costs and time. The Streets & Trips program also contains an option of downloading current road construction information to allow the program to suggest routes that avoid roads under construction.

Motorists can also obtain information through on-line mapping services. Such services allow a user to specify an origin and a destination of a trip. The mapping service computes a route for the trip, indicating which roads the user should take. The route might be presented to the user as a map or as a list of roads. The MICROSOFT® MAPPOINT® mapping service is an example of an on-line mapping service.

The MAPPOINT® mapping service may be accessed through a control, which is a programming construct that provides an interface to one or more functions, such as those provided by the MAPPOINT® mapping service. The control can be integrated with other software so that the functions accessed through the control are accessed from that software. In this way, the features of the MAPPOINT® mapping service may be incorporated into other web sites without detailed knowledge of its operation.

For example, a web site designer for a retail store can incorporate a control for the MAPPOINT® mapping service in a website for the store to allow customers using the store website to access the mapping service. When a customer accesses the website through a web browser on a client computer, the mapping service control can be downloaded to the client computer. In operation, the control can be configured to create an output display in a field in the web browser window displaying the store website. The customer can interact with the mapping service through the control, such as to get customized driving directions.

Motorists can also receive information from traffic alert systems that proactively send new information when it is available. Traffic alert systems send information to motorists about traffic problems, such as accidents or breakdowns, as the problems occur. An example of a traffic alert system is the MSN® Autos™ traffic alert system.

### SUMMARY OF INVENTION

In one aspect, the invention relates to a traffic alert system that receives a user alert profile that identifies a route of interest to the user. That information is used to create a filter for that user. The system filters information about traffic conditions and communicates appropriate traffic alerts to the user.

In another aspect, the invention is described as a method of operating a traffic alert computer system that includes providing a user interface that enables a user to specify a route to be used to create a filter.

In one aspect, the invention relates to a traffic alert system that includes a computer system adapted to exchange information with at least one user and to receive traffic information from a source of information about traffic conditions. The system includes at least one storage medium. Computer executable instructions in the system can cause the computer system to receive from the at least one user an alert profile comprising at least one route; store filter information in the storage medium based on the alert profile; compare traffic information obtained from the source of information about traffic conditions to the filter information; and communicate a traffic alert to the at least one user when the traffic information indicates a traffic problem matching the filter information based on the alert profile received from the at least one user.

In another aspect, the invention relates to a method of operating a traffic alert computer system, including providing on a user interface at least one filter interface in which a user may specify filter information for traffic alerts. The filter information includes at least one route.

In another aspect, the invention relates to a method of operating a traffic alert system, that includes receiving from a user route information identifying at least one route; comparing the route information to traffic information of traffic problems to filter the traffic information to identify user relevant traffic problems correlated with at least one road in the route; and communicating to a client device an electronic message alerting the user to the user relevant traffic problem.

In another aspect, the invention relates to a method of receiving customized traffic alerts that involves providing a traffic alert system with filter information that specifies at least one criteria defining traffic alerts relevant to a user. This filter information specifies at least one route. Traffic alerts regarding traffic problems correlated to at least one road in the at least one route are then received.

Other aspects of the invention, as well as specific embodiments, are described below.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a simplified block diagram of a traffic alert system;

FIG. 2 is a sketch of a prior art user interface for a traffic alert system;

FIG. 3 is a sketch of a map output by a prior art traffic alert system;

FIG. 4 displays the web-based user interface according to one embodiment of the invention; and

FIG. 5 is a flow chart useful in understanding the business logic according to one embodiment of the invention.

### DETAILED DESCRIPTION

Applicants have appreciated that with existing traffic alert systems some users may receive too much information or information of low relevance to the user, which is undesirable.

In accordance with one embodiment of the invention, the usability of a traffic alert system is greatly increased by reducing the total number of alerts that are likely to be sent to each user, but retaining the alerts that are of interest to the user. The user interface of the system allows the user to specify one or more routes and to only receive alerts about traffic problems impacting those routes. In this way, the number of alerts is decreased and the overall quality of the alerts sent to the user is increased.

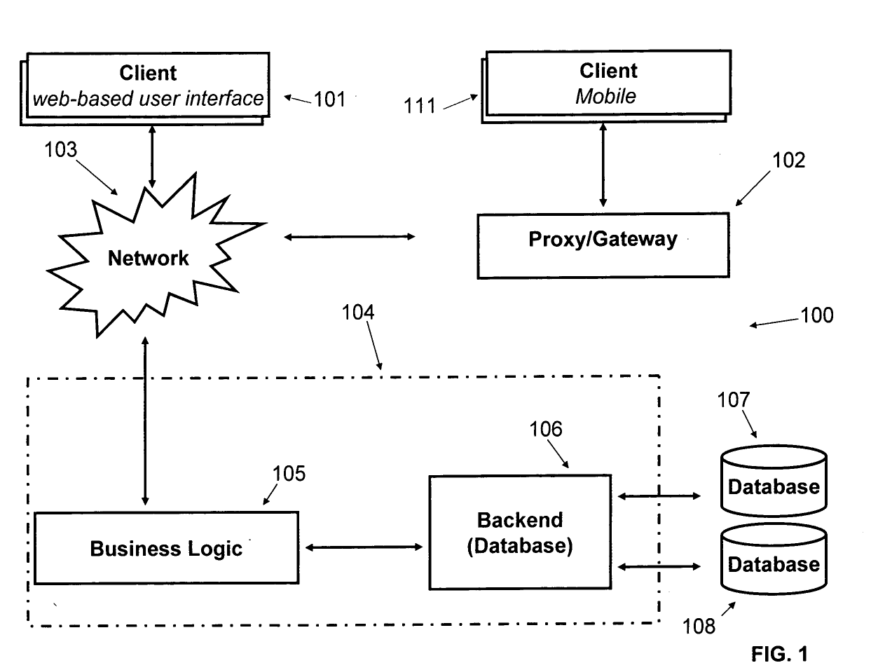

In one embodiment described below, the aspects of the present invention are implemented on a traffic alert system having an architecture illustrated in FIG. 1, which is similar to the prior art. However, the present invention is not limited in this respect, and can be implemented on a system having any suitable configuration.

One embodiment is created by modifying an existing traffic alert system. The user interface is modified to allow a user to specify a particular route and the system is modified to filter traffic alerts and to provide to the client only those alerts that indicate a problem impacting the specified route.

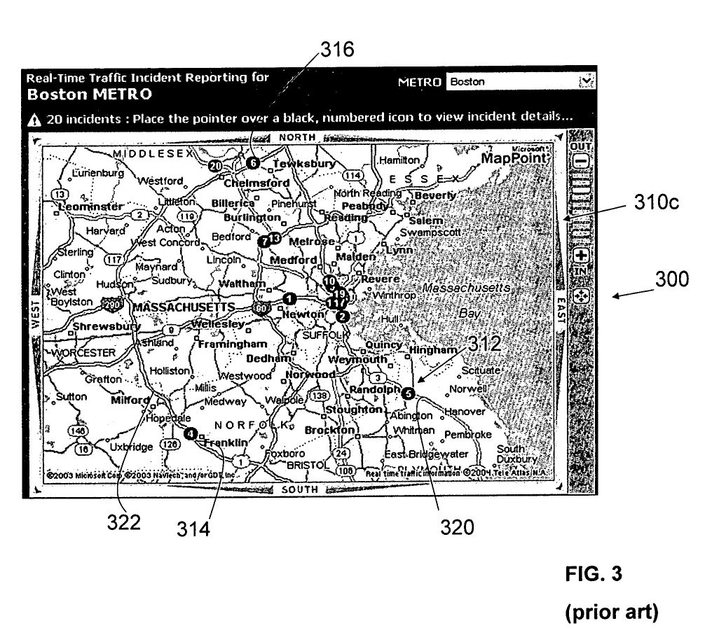

Benefits of such features are illustrated by FIG. 3. In addition to providing traffic alerts meeting a traffic alert profile specified by the user, prior art traffic alert systems provided information on traffic problems in graphical form in response to specific requests by a user. FIG. 3 indicates an output screen 300 such as might be displayed by a prior art traffic alert system in response to a user request.

Output screen includes a map 310. Map 310 is generated in this example by a MICROSOFT® MAPPOINT® mapping service control. Superimposed on the map are incident indicators such as 312, 314 and 316. Output screen 300 shows multiple traffic problems existing in a particular metro area. These traffic problems exist on different roads. For example, the traffic problem represented by incident indicator 312 is on road 320, while the traffic problem represented by incident indicator 314 in on road 322. Some motorists may not be interested in information about both roads 320 and 322. Nonetheless, if both of those roads fall within metro regions a user has specified when establishing an alert profile, a prior art system would send the user alerts concerning both incidents.

As another example, incident indicators 314 and 316 correspond to traffic problems on road 322. However, the locations of the traffic problems corresponding to incident indicators 314 and 316 are far enough apart that many motorists driving on road 322 will not drive on both sections where those traffic problems exist. Thus, some motorists will not benefit from receiving information about both of the traffic problems represented by incident indicators 314 and 316.

This example illustrates that even when a user specifies a region within a metro area, the specified region will include more roads than a user is likely to drive on in any given day. Further, a user might drive through multiple metro regions on a trip. Therefore, to receive all of the traffic alerts which are of interest using a prior art traffic alert system, the user might have to specify multiple metro regions. Thus, even though prior systems included the ability to limit traffic alerts by metro region, Applicants have recognized that users of such systems are receiving a large number of alerts, some of which are not necessary.

Applicants have further appreciated that alerts sent to a mobile device can be particularly disruptive for the user, as each alert has the potential to interrupt the user from performing important tasks. Applicants have further appreciated that receiving a large number of traffic alerts which are not meaningful to the user can condition the user to ignore all alerts from the system. Thus, even when important information is sent in an alert, because of conditioning, the user may ignore the alert.

Applicants have further appreciated that users might incur a charge for each alert, either imposed by the service providing the traffic alert system or for receiving each alert on a mobile phone.

It would be desirable to provide an improved traffic alert system that is more targeted and convenient for users. Such an improved system is described below.

FIG. 1 shows in block diagram form a traffic alert system 100. Traffic alert system 100 might be implemented as in the prior art, adapted to employ additional features as described herein.

Server 104 is connected over a network 103 to client 101. Network 103 may be the Internet and client 101 may be a standard web browser installed on a stationary computer system, such as a desktop computer.

Server 104 is also connected to a mobile client 111. The connection to mobile client 111 is made over network 103 through a gateway 102. Gateway 102 can be, for example, a gateway to a mobile public switched telephone system. Mobile client 111 might be text messaging software on a cellular telephone.

In a typical application, a user provides information to server 104 through client 101. Such information includes an identification of a region for which the user would like to receive alerts and an electronic address to which alerts should be sent. Based on this information, server 104 generates and sends alerts.

Server 104 is connected to one more or databases. In the illustrated embodiment, a user database 107 and a problem database 108 are shown. User database 107 stores information about users of the traffic alert system that is used to generate alerts. User database 107 might also store billing information about the client to allow charges to be assessed as alerts are provided to the user. Problem database 108 represents a source of information about traffic problems. Problem database 108 could reside on physical storage associated with server 104. Alternatively, the problem data might be provided as a data stream from a third party data provider. In the latter case, database 108 is a logical representation of a source of data rather than physical hardware connected to server 104.

A backend interface 106 on the server interacts with databases 107 and 108 to retrieve and store data. Backend 106 may be a commercially available database program.

Business logic 105 interfaces with client 101 and/or client 111 and backend 106. Business logic 105 receives input from a user through client 101. Business logic 105 processes this information and then, through backend 106, stores the processed information in user database 107.

Multiple users can access the system through the client interfaces. Business logic 105 interfaces to all the clients, but only one such client 101 is shown for simplicity. User database 107 stores information about all the users in a way to create a correspondence between a specific user and the information provided by that user.

Business logic 105 periodically compares information about users stored in user database 107 to information about traffic problems from problem database 108. When business logic 105 identifies a traffic problem that requires an alert to be sent to a particular user, business logic 105 sends a message or traffic alert to that user.

Multiple methods are available for communicating a traffic alert to a user. The alert might be communicated by e-mail sent through network 103 to the client 101. Alternatively, business logic 105 might communicate over network 103 to a gateway 102 that can transmit a text message to a mobile client 111 over the mobile public switched telephone network.

Traffic alert system 100 is constructed as a traditional client-sever based web application. Controls such as drop down list boxes and check boxes are well known. These controls can display information for a user or receive information from the user accessing these controls through the client. Accessing these controls can cause information based on user input to be communicated to the server. In this specific example, the information communicated to the server is an alert profile specifying the situations in which a specific user should receive a traffic alert. The server generates traffic alerts for specific users based on the alert profiles corresponding to those users.

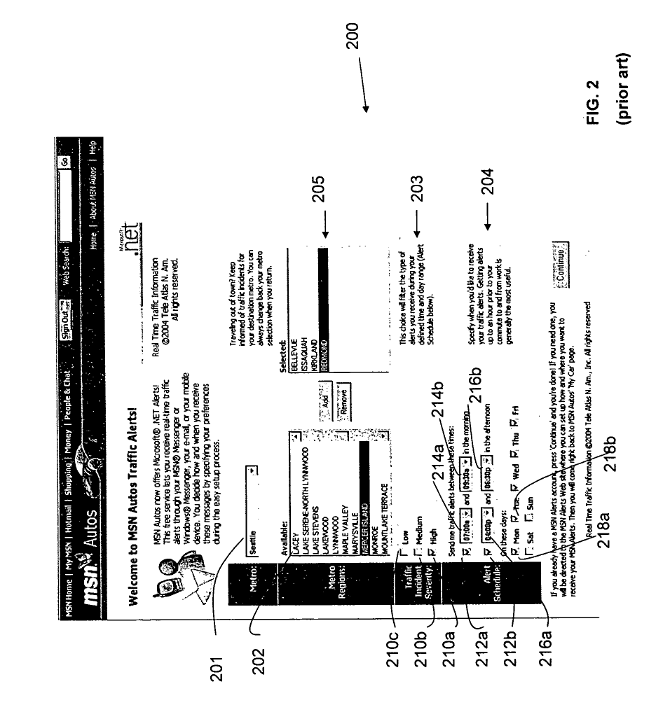

FIG. 2 represents the web-based user interface 200 of a prior art version of the MSN® Autos™ traffic alert system. Interface 200 can be presented to a user by client 101, such as a web browser.

To provide information to business logic 105 through interface 200, a user first selects a metro area using field 201. Field 201 is a drop down list box providing a list of metro areas for which traffic information is available. A user may select a metro area by selecting an entry from the list. The client communicates the selection to server 104.

When the user selects a metro area, business logic 105 populates field 202 with regions within that metro area for which traffic information is available. The user can then specify a metro region from the list of regions in field 202. Window 205 displays metro regions selected by the user.

User interface 200 also provides the user an opportunity to specify a severity filter and a time filter. Section 203 of user interface 200 allows the user to specify the severity of alerts the user wishes to receive. Section 203 includes check boxes 210A, 210B, 210C. Check box 210A corresponds to high severity incident. Check box 210B corresponds to medium severity incident, and check box 210C corresponds to a low severity incident. In the example of FIG. 2, the user has selected check box 210A, indicating that the user wishes to receive only alerts about high severity incidents.

Section 204 of user interface 200 provides the user with an opportunity to specify a time filter. Section 204 includes check boxes 212A and 212B that allows the user to indicate whether the user wishes to receive traffic alerts in the morning and in the afternoon, respectively. When check box 212A is selected, the user may use fields 214A and 214B to specify a starting and ending time, respectively, for receiving traffic alerts in the morning. Fields 214A and 214B are implemented as drop down list boxes. In a similar fashion, check box 212B allows the user to specify a starting and ending time for receiving traffic alerts in the afternoon. When check box 212B is checked, the user may use fields 216A and 216B to specify a starting and ending time, respectively, in the afternoon.

Section 204 further includes check boxes (of which only 218A and 218B are numbered for simplicity) that allow the user to specify days of the week on which the user wishes to receive traffic alerts.

The user interface of FIG. 2 can be readily modified to incorporate novel features as described below.

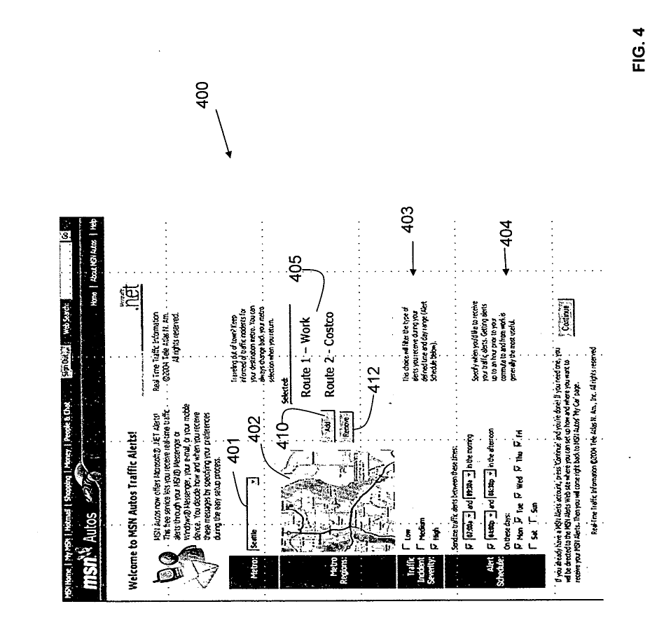

FIG. 4 illustrates a user interface according to one embodiment of the invention, and is a sketch of a web-based user interface 400. User interface 400 may be presented to a user through a client 101, such as a traditional web browser, or in any suitable manner. The user interface may be said to be provided by the client even though some information needed to generate the display is transmitted from the server. Client 101 may run on a desktop PC, which includes a display (so that information may be presented to a user in graphical form) and user input devices, such as a keyboard and a mouse or on any other suitable device. The user may input information through the client by manipulating a mouse to position a cursor over a field and “clicking” on that field. Clicking on a field on the display activates “control” software associated with the field, which performs the desired operation in response, which might include accepting text input though the keyboard. Such a user interface is described merely for illustrative purposes, as any suitable technique for presenting and operating a user interface may be employed.

User interface 400 includes a mapping control 402, which may be a control to an existing mapping service, such as the MAPPOINT® mapping service. By accessing control 402, a user may specify an origin and a destination, and control 402 communicates that information to the mapping service. The mapping service then computes a route and provides as an output the roads within the route. This information may be passed through the interface provided by control 402 to client 101. In the interface of FIG. 4, the information on the route obtained through control 402 is displayed to the user in graphical form. The route information from the mapping service is also available through control 402 in a computer readable form so that client 101 may store or transmit an indication of the route computed by the mapping service.

While a mapping service is used to provide information to the user regarding a desired note, it should be appreciated that the invention is not limited in this respect, as the desired rate may be specified in any suitable way (e.g., manually by the user).

Interface 400 has further controls that allow the user to select the displayed route as a route for which the user wishes to receive traffic alerts. Any convenient control can be used to allow the user to select the route. In the illustrated embodiment, interface 400 includes an “Add” control 410. When selected, Add control 410 brings up a dialog box that allows the user to give a name to the designated route. The designated route is then sent by client 101 to server 104 where business logic 105 stores the route information in user database 107 in a record associated with the specific user.

Business logic 105 populates field 405 with names of routes specified by the user. In the example illustrated in FIG. 4, two routes appear in field 405. Interface 400 can optionally also include controls that allow these routes to be managed. For example, interface 400 is shown with a “Remove” control 412 that allows the user to delete a selected specified route. When activated, remove control 412 causes client 101 to transmit information to server 104 indicating that a route is to be deleted. In response, business logic 105 deletes the entry in user database 107 that indicates the user wishes to receive alerts concerning problems on that route.

In one embodiment, user interface 400 also can include controls that allow a user to specify other parameters of an alert profile, such as those found in prior art traffic alert systems. Section 403 contains controls that allow the user to specify the severity of the traffic problem in the same way that this information was specified through section 203 of the interface of the prior art system of FIG. 2. In the example of FIG. 4, the user has the option of selecting low, medium or high severity of the traffic problems for which alerts are to be provided, but it should be appreciated that numerous other options and levels of granularity are possible.

Interface 400 also provides a section 404 through which a user may specify an alert schedule. As with section 204 in a prior art interface of FIG. 2, a user may specify that alerts are to be sent only during a specific time in the morning and/or in the afternoon. Days of the week when the traffic alerts are to be sent may also be specified through controls in section 404.

Further, user interface 400 may include a drop down menu box 401. The user, via a client such as 101 or 111, has the option of selecting a metro area from a drop down menu box. Selecting a metro area, although not necessary, eases the process of specifying the addresses for route generation. Any street address indicating the origin or destination of a route will be interpreted by mapping control 402 as being within the specified metro area.

User interface 400 may also include a metro region section, such as section 202 in the prior art. The user's specified route may go through several metro regions. A user may only be interested in receiving alerts from a subset of those metro regions. Therefore choosing a metro region in connection with a route will further filter unnecessary data.

Business logic 105 may be implemented using web based application operating in the client-server configuration shown, and using any suitable file format and programming language (e.g., OPAS or SQL).

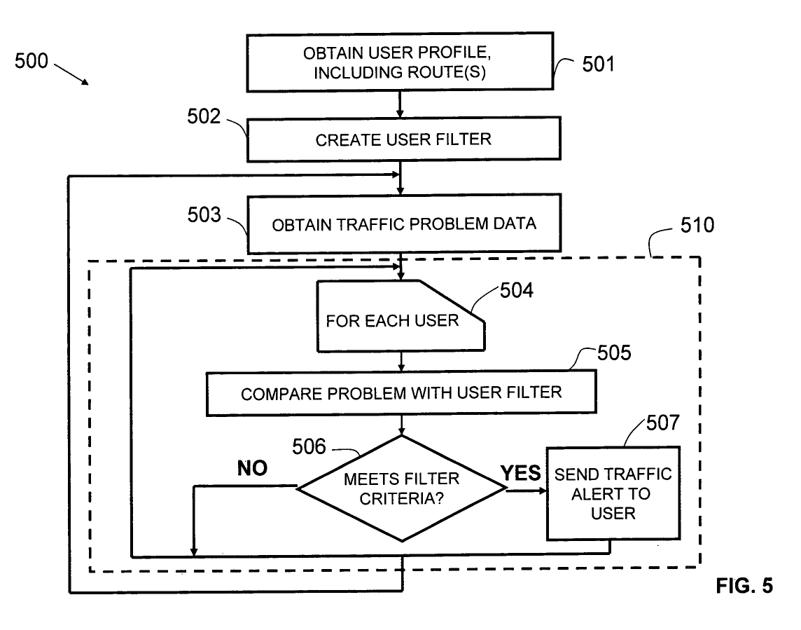

FIG. 5 is a flow chart illustrating one exemplary process 500 that may be performed by business logic 105 on server 104. The process begins at act 501 where an alert profile is obtained from a user via a client 101.

At act 502, business logic creates a filter based on the alert profile specified by the user. The filter is stored in user database 107 (FIG. 2) in a way that creates a correspondence between the user that entered the alert profile and the filter information. For example, user information can be a field in each record in database 107. The system can be constructed to allow a user to specify more than one alert profile, in which case each alert profile may generate an entry in user database 107.

At act 503, business logic 105 obtains traffic problem data. Traffic problem data can be obtained from a traffic problem database 108, or any other source. Traffic problem database may be a physical storage location associated with server 104, or may be a source of data obtained from a third party data provider.

Regardless of the specific source of the traffic problem data, the traffic problem data is repetitively compared to user filters to determine which users should receive alerts. Various methods can be used to schedule these comparisons and the sending of alerts, as the invention is not limited in this respect. Process 500 illustrates a simple scheduling algorithm employing a loop that can be coded into business logic 105, but any convenient scheduling algorithm can be employed.

At act 504, a loop 510 is established over all the users that have alert profiles stored in user database 107. At act 505, the identified traffic problems are compared to the user filters stored for each user at act 502.

At act 506, a determination is made as to whether traffic problem information matches the criteria stored as a filter for a particular user. If the traffic problem matches the filter stored for a particular user, the process proceeds to act 507. In the example illustrated in FIG. 4, a traffic problem matches a filter when the problem impacts a road along a specified route in section, has a severity matching a severity specified in section 403 and occurs during a time specified in section 404, although other matching criteria can be employed.

At act 507, a traffic alert is sent to the appropriate user. The traffic alert is sent to the user at the electronic address specified for the user when the user profile was created. The electronic address may, for example, be an e-mail address, identify a mobile telephone or other handheld electronic device, or be any other suitable information.

Conversely, if the traffic problem information does not meet the filter criteria for the user, no alert is sent. The process proceeds with loop 510 returning to act 504 where the next user is selected. Loop 510 repeats for that user, and an alert is sent to the user if the traffic problem information matches the traffic alert profile specified by the user.

The process repeats for other users in the same fashion. When loop 510 is completed, the process returns to act 503 where current traffic problem data is obtained. Preferably, traffic problem data is kept current in some fashion such that new traffic problem reports are be continuously or regularly available.

Advantageously, a traffic alert is sent only to a user when the traffic problem data indicates a problem impacting a road in which the user has specified as being of interest. The total number of alerts sent to a user can therefore be significantly decreased. Particularly in the case where alerts are being transmitted to a mobile client 111, reducing the total amount of information transmitted to the client can be a significant benefit.

In addition, the quality of the information is greatly increased. Only reports of problems that are of interest to the particular user are transmitted to that user, thereby increasing the usability of the system.

Having thus described several aspects of at least one embodiment of this invention, it is to be appreciated various alterations, modifications, and improvements will readily occur to those skilled in the art.

As one example, user log-on, account management functions and other interactions traditionally found in applications provided through the Internet are not expressly shown. However, such functions might be readily included.

Also, the system may include some process for keeping traffic reports current. If traffic problem data is stored in a database, preferably entries in the database are removed once they are “stale.” For example, traffic problem data received at server 104 might indicate, in addition to reports of new problems, that previously reported problems have been resolved. Alternatively, a time stamp may be appended to each traffic problem report as it is stored in the database and reports in a database older than some predetermined time may be deleted. A suitable process for processing only current traffic information can be included in the system described above.

Furthermore, user database 107 can be readily modified to store information about alerts sent to users. The information may be used as part of a billing system, if users are charged for each alert they receive. Such information might also be used as a further filter criteria. Business logic 105 may be programmed not to send alerts of traffic problems that have previously been reported to a user or where a user has been previously informed of multiple traffic problems affecting a road. Such filtering might be adaptive based on the severity of the reports. For example, the system may send a report if a higher severity traffic problem that was reported affecting the same road is indicated, but not send a report of a lower severity report when a higher severity report was previously sent.

Also, it was described above that a user may enter a traffic alert profile through a stationary PC. However, any computing device with a connection to server 104, such a as a web enabled mobile phone or a PDA, can be used to enter information. Further, a system can be constructed with an alternative user interface that allows routes to be specified directly from a mobile client device.

As another example, scheduling algorithms other than the one shown in FIG. 5 can be employed. The scheduling might be implemented by the manner in which information is stored in the database and the traffic problem information is provided. For example, alert profiles may be stored in user database 107 indexed by the time range in which alerts are to provided. As information is obtained on each traffic problem, business logic 105 may compare the problem only to alert profiles indicating that the user wishes to receive alerts at the current time. If traffic problem information is provided in a continuous stream, with the stream containing only information about currently existing problems, scheduling may be achieved by the incoming traffic problem reports triggering a comparison to the alert profiles in the database.

Further, in the embodiment above, traffic problems were described as impacting a route only when the problem occurred on a road along that route. In an alternate embodiment, the system may be programmed to recognize roads with correlated traffic patterns. For example, roads that represent alternative commuter arteries may be identified as correlated because a problem on one commuter artery is likely to cause many commuters to alter their commute to use the other artery. Thus, an alert might be sent to a user who specified a route including a second commuter artery when a problem is impacting a first commuter artery. In such a scenario, the alert might warn of expected heavier traffic volume along that user's route.

As an example of another variation, it was described above that routes were specified by entering an origin and the destination of the route into a control to a mapping service. Routes might be specified in other ways. For example, a user might specify a metro area and/or a metro region. The mapping program might then provide a map. The user might specify routes by selecting individual roads in the map.

As a further variation, the content of the alert might be customized based on the information in the alert profile specified by the user. For example, once user database 107 contains information about the origin and destination for the user's desired route, business logic 105 can be programmed to, in addition to sending traffic alerts, send information about alternative routes between that origin and destination that do not contain traffic problems.

As a further variation, it is described that a control for a mapping service is interfaced to client 101. Client 101 might alternatively contain an interface to a mapping program, such as MICROSOFT® Streets & Trips™ mapping program, or the client need not determine the specific roads in a route. The client may communicate to the server the origin and destination of the route and the server may access the required information about roads, such as by accessing a mapping service, a mapping program or a database resident on the server or in any other suitable manner.

Client 101 is described above to be resident on a PC connected to the Internet and mobile client 111 is described as being resident on a portable electronic device, such as a mobile phone. However, these are examples only. In one embodiment, client 111 is mobile so that it will be with the user or in the user's car when a traffic alert occurs. However, it is not necessary that client 111 be mobile. For example, client 111 could be implemented as a user's office computer. Likewise, it is not necessary that client 101 be stationary. Either client could be implemented by software running on hardware that includes, but is not limited to, personal computers, server computers, hand-held or laptop devices, multiprocessor systems, microprocessor-based systems, programmable consumer electronics, network PCs, cellular phones, minicomputers, mainframe computers, distributed computing environments that include any of the above systems or devices, and the like. Likewise, server 104 may reside on any convenient computer system, such as a single or multiprocessor computer.

The aspects of the invention described herein are not limited in their application to the details of construction and the arrangement of components set forth in the above description or illustrated in the drawings, as these aspects are capable of other embodiments and of being practiced or of being carried out in various ways. Also, the phraseology and terminology used herein is for the purpose of description and should not be regarded as limiting.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A traffic alert system comprising:
a computer system adapted to exchange information with at least one user and to receive traffic information from a source of information about traffic conditions;
at least one storage medium; and
computer executable instructions for causing the computer system to:
receive from the at least one user an alert profile comprising at least one route;
store filter information in the storage medium based on the alert profile;
compare traffic information obtained from the source of information about traffic conditions to the filter information; and
communicate a traffic alert to the at least one user when the traffic information indicates a traffic problem matching the filter information based on the alert profile received from the at least one user.

2. The traffic alert system of claim 1, wherein the at least one storage medium comprises at least one database.

3. The traffic alert system of claim 2, wherein the computer system is adapted to exchange information with the user over a network.

4. The traffic alert system of claim 2, wherein the computer systems comprises a server, and the computer executable constructions comprise business logic and a database backend.

5. The traffic alert system of claim 3, additionally comprising a plurality of client computers coupled to the computer system through the network, and wherein the computer system is adapted to exchange information with the at least one user via at least one of the plurality of client computers.

6. The traffic alert system of claim 5, wherein the network includes the Internet.

7. The traffic alert system of claim 5, wherein the network includes a mobile public switched telephone network.

8. The traffic alert system of claim 7, wherein the network includes the Internet and the mobile public switched telephone network is connected to the Internet through a gateway.

9. The traffic alert system of claim 1, wherein the alert profile comprises time of day criteria, and wherein the filter information includes time related information based upon the time of day criteria.

10. The traffic alert system of claim 1, wherein the at least one route in the alert profile comprises at least one road, and wherein the computer executable instructions cause the computer system to communicate traffic alert information to the at least one user when a traffic problem exists on a road that is not included in the at least one route but is correlated with at least one road in the at least one route.

11. A method of operating a traffic alert computer system, the method comprising acts of:
(a) providing on a user interface at least one filter interface in which a user may specify filter information for traffic alerts, the filter information comprising at least one route.

12. The method of claim 11, further comprising an act of displaying the at least one routes specified by a user in the filter information.

13. The method of claim 11, wherein the act (a) comprises an act of displaying an interface to a control to an on-line mapping service so that the user may select the at least one route from a plurality of routes specified by the on-line mapping service.

14. The method of claim 11, wherein the act (a) comprises an act of providing at least one filter interface that enables the user to specify the at lease one route by specifying an origin and destination of the at least one route.

15. The method of claim 11, wherein the act (a) comprises an act of providing at least one filter interface that displays a map that the user can interact with to specify the at least one route.

16. A method of operating a traffic alert system, comprising acts of:
(a) receiving from a user route information identifying at least one route comprising at least one road;
(b) comparing the route information to traffic information of traffic problems to filter the traffic information to identify user relevant traffic problems correlated with the at least one road; and
(c) when a user relevant traffic problem is identified in the act (b), communicating to a client device an electronic message alerting the user to the user relevant traffic problem.

17. The method of claim 16, wherein the act (c) comprises an act of sending an e-mail message to the client device.

18. The method of claim 16, wherein the client device is a mobile phone, and wherein the act (c) comprises sending a text message to the mobile phone.

19. The method of claim 16, wherein the act (c) comprises sending a message formatted for display on a PDA.

20. The method of claim 16, wherein the act (a) comprises receiving information identifying roads in the at least one route from a mapping service.

21. The method of claim 16, wherein the act (a) comprises an act of receiving from the user an indication of an origin and destination of the at least one route.

22. The method of claim 21, further comprising an act of determining the at least one road in the at least one route between the origin and destination.

23. The method of claim 16, wherein the act (c) comprises an act of communicating an electronic message alerting the user to a traffic problem on a road that is not included in the at least one route but is likely to impact traffic on at least one road in the at least one route.

24. The method of claim 16, wherein the route comprises one or more roads connecting an origin and a destination and wherein the method further comprises an act of selecting a different route between the origin and the destination.

25. A method of receiving customized traffic alerts from a traffic alert system, comprising acts of:
(a) providing to the traffic alert system filter information specifying at least one criteria defining traffic alerts relevant to a user, the filter information specifying at least one route; and
(b) receiving traffic alerts regarding traffic problems correlated to at least one road in the at least one route.
